(19) United States
(12) Patent Application Publication
(10) Pub. No.: US 2024/0022342 A1
(43) Pub. Date: Jan. 18, 2024

(54) REDUCING INTERFERENCE AND OPTIMIZING PARAMETER

(71) Applicant: Nokia Technologies Oy, Espoo (FI)

(72) Inventors: Xia NI, Hangzhou (CN); Lingliang HU, Hangzhou (CN); Kexing WANG, Hangzhou (CN)

(21) Appl. No.: 18/251,847

(22) PCT Filed: Nov. 10, 2020
(86) PCT No.: PCT/CN2020/127773

§ 371 Date: May 4, 2023

(51) Int. Cl. H04B 17/345; H04B 17/391; H04W 72/542

(52) U.S. Cl. CPC H04B 17/345; H04B 17/3913; H04W 72/542

(57) ABSTRACT

Embodiments of the present disclosure relate to solutions for reducing interference and optimizing parameter. A first device measures interference on a frequency resource in a scheduling interval. If strength of the interference exceeds a threshold, the first device determines an interfering device by using a model trained with strength of previous interference and previous scheduling information of a plurality of candidate devices. In this way, the interfering device may be identified accurately and quickly and the interference may be reduced accordingly. In addition, a second device determines and transmits performance information to a third device. Then, the second device receives a parameter for adjusting transmission power from a third device. The parameter is determined based on respective performance information of a plurality of devices comprising the second device to maximum overall performance of the plurality of devices. In this way, the overall performance of the communication is improved.

### FIELD

Example embodiments of the present disclosure generally relate to the field of communication techniques and, in particular, to devices, methods, apparatuses and computer readable storage medium for reducing interference and optimizing parameter.

### BACKGROUND

Wireless communication networks are widely deployed and can support various types of service applications for terminal devices. Generally speaking, a wireless communication system is designed to allow a large number of terminal devices to access communication infrastructures via wireless media simultaneously. Further, in order to cover a large area, multiple access devices (such as, base stations, BSs) are deployed, where each access device covers one sub-area (such as, a cell). In addition, core devices also are deployed to manage the multiple access devices in the area.

It is known that the frequency band available for wireless communication is limited. In order to increase the utilization efficiency of the available frequency band, in current wireless communication system, it is desirable for some cells (with their corresponding terminal devices and access devices) to use the same frequency band, which is referred to as frequency re-use. In this event, it is inevitably that intra-frequency Interference may occur among different cells. Therefore, it is a challenge to maximize the overall performance of the wireless communication system and reduce intra-frequency interference between a plurality of neighbor cells.

### SUMMARY

In general, example embodiments of the present disclosure provide solutions for reducing interference and optimizing parameter. Embodiments that do not fall under the scope of the claims, if any, are to be interpreted as examples useful for understanding various embodiments of the disclosure.

In a first aspect, there is provided a first device. The first device comprises at least one processor; and at least one memory including computer program code; where the at least one memory and the computer program code are configured to measure interference on a frequency resource in a first scheduling interval. The first device is further caused to in accordance with a determination that the strength of interference exceeds a threshold, determine, by using a trained model and from a plurality of candidate devices, an interfering device correlated with the interference. The model is trained with strength of previous interference measured on the frequency resource in previous scheduling intervals and previous scheduling information of the plurality of candidate devices on the frequency resource in the previous scheduling intervals. The first device also is caused to transmit, to the interfering device, a first message indicating that the second device is correlated with the interference.

In a second aspect, there is provided a second device. The second device comprises at least one processor; and at least one memory including computer program code; where the at least one memory and the computer program code are configured to determine, based on a set of performance indicators of the second device, performance information about the second device in an adjusting interval. The second device is further caused to transmit the performance information to a third device. The second device also is caused to receive, from the third device, a parameter for adjusting transmission power to be used by the second device in a subsequent adjusting interval. The parameter is determined based on respective performance information of a plurality of devices comprising the second device to maximum overall performance of the plurality of devices.

In a third aspect, there is provided a third device. The third device comprises at least one processor; and at least one memory including computer program code; where the at least one memory and the computer program code are configured to receive, from a plurality of devices, respective performance information in an adjusting interval. The third device is further caused to determine, based on the received performance information, respective parameters for adjusting transmission power to be used by the plurality of devices in a subsequent adjusting interval, such that overall performance of the plurality of devices is maximized. The third device also is caused to transmit the respective parameters to the plurality of devices.

In a fourth aspect, there is provided a method. The method comprises measuring, at a first device, interference on a frequency resource in a scheduling interval. The method further comprises in accordance with a determination that the strength of interference exceeds a threshold, determining, by using a trained model and from a plurality of candidate devices, an interfering device correlated with the interference. The model is trained with strength of previous interference measured on the frequency resource in previous scheduling intervals and previous scheduling information of the plurality of candidate devices on the frequency resource in the previous scheduling intervals. The method also comprises transmitting, to the interfering device, a first message indicating that the interfering device is correlated with the interference.

In a fifth aspect, there is provided a method. The method comprises determining, at a second device and based on a set of performance indicators of the second device, performance information about the second device in an adjusting interval. The method further comprises transmitting the performance information to a third device. The method also comprises receiving, from the third device, a parameter for adjusting transmission power to be used by the second device in a subsequent adjusting interval. The parameter is determined based on respective performance information of a plurality of devices comprising the second device to maximum overall performance of the plurality of devices.

In a sixth aspect, there is provided a method. The method comprises receiving, at a third device and from a plurality of devices, respective performance information in an adjusting interval. The method further comprises determining, based on the received performance information, respective parameters for adjusting transmission power to be used by the plurality of devices in a subsequent adjusting interval, such that overall performance of the plurality of devices is maximized. The method also comprises transmitting the parameters to the plurality of devices.

In a seven aspect, there is provided a first apparatus. The first apparatus comprises means for measuring, interference on a frequency resource in a scheduling interval. The first apparatus further comprises means for in accordance with a determination that strength of the interference exceeds a threshold, determining, by using a trained model and from a plurality of candidate apparatuses, an interfering apparatus correlated with the interference. The model is trained with strength of previous interference measured on the frequency resource in previous scheduling intervals and previous scheduling information of the plurality of candidate apparatus on the frequency resource in the previous scheduling intervals. The first apparatus also comprises means for transmitting, to the interfering apparatus, a first message indicating that the interfering apparatus is correlated with the interference.

In an eighth aspect, there is provided a second apparatus. The second apparatus comprises means for determining based on a set of performance indicators of the second apparatus, performance information about the second apparatus in an adjusting interval. The second apparatus further comprises means for transmitting the performance information to a third apparatus. The second apparatus also comprises means for receiving, from the third apparatus, a parameter for adjusting transmission power to be used by the second apparatus in a subsequent adjusting interval. The parameter is determined based on respective performance information of a plurality of apparatuses comprising the second apparatus to maximum overall performance of the plurality of apparatuses.

In a ninth aspect, there is provided a third apparatus. The third apparatus comprises means for receiving, at a third apparatus and from a plurality of apparatuses, respective performance information in an adjusting interval. The third apparatus furthers comprises means for means for determining, based on the received performance information, respective parameters for adjusting transmission power to be used by the plurality of apparatuses in a subsequent adjusting interval, such that overall performance of the plurality of apparatuses is maximized. The third apparatus also comprises means for transmitting the respective parameters to the plurality of apparatuses.

In a tenth aspect, there is provided a computer readable medium. The computer readable medium comprises program instructions for causing an apparatus to perform at least the method according to the fourth aspect.

In an eleventh aspect, there is provided a computer readable medium. The computer readable medium comprises program instructions for causing an apparatus to perform at least the method according to the fifth aspect.

In a twelfth aspect, there is provided a computer readable medium. The computer readable medium comprises program instructions for causing an apparatus to perform at least the method according to the sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which some example embodiments of the present disclosure may be implemented;

FIG. 2 illustrates an example signaling chart for reducing interference in the communication system between devices in accordance with some embodiments of the present disclosure;

FIG. 3 illustrates an example graph of the function for generating the model in accordance with some embodiments of the present disclosure;

FIG. 4 illustrates another example communication network in which other example embodiments of the present disclosure may be implemented;

FIG. 5 illustrates another example signaling chart for optimizing parameter in the communication system between devices in accordance with some embodiments of the present disclosure;

FIG. 6 illustrates an example flowchart of a method implemented at a first device according to some example embodiments of the present disclosure;

FIG. 7 illustrates an example flowchart of a method implemented at a second device according to some example embodiments of the present disclosure;

FIG. 8 illustrates an example flowchart of a method implemented at a third device according to some example embodiments of the present disclosure;

FIG. 9 illustrates a simplified block diagram of an apparatus that is suitable for implementing example embodiments of the present disclosure; and

FIG. 10 illustrates a schematic diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular fourth device, or other computing or fourth device.

Communications discussed herein may use conform to any suitable standards including, but not limited to, New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a first device and a fourth device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system

The term “core device” refers to any device or entity that provides management or maintaining in the communication system. By way of example rather than limitation, the core device may be an AMF, a SMF, a UPF, etc. In other embodiments, the core device may be any other suitable device or entity.

As used herein, the term “network device” refers to a node in a communication network via which terminal devices accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground fourth device such as a satellite fourth device, a low earth orbit (LEO) satellite and a geosynchronous earth orbit (GEO) satellite, an aircraft fourth device, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a tag with wireless communication capability, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IOT device or fixed IOT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

It is known that one key factor affecting the performance of the communication of network is interference. As discusses above, in the wireless communication system, the frequency band used for communication is limited. Further, in order to provide better services to the terminal devices, the service providers and operators usually deploy multiple access devices, such as, access point (AP), femto BS, micro BS and the likes. Therefore, there are a large number of access devices with different types in the wireless communication system. In the conventional communication system, there are two common manners for utilizing the frequency resource among the access device, also referred to as a single-frequency network and a multi-frequency network. More specifically, in the single-frequency network, all the access devices may use the same frequency band. In this way, the frequency resource used by each of the access network is maximized. In the multi-frequency network, the total frequency band may be divided into different sub-frequency bands, such as, three different sub-frequency bands. Then, each of the access networks may be allocated with one of the divided different sub-frequency bands. In the multi-frequency network, interference is reduced at a cost of reducing the available frequency resource for each access network. However, as the number of the access devices is a relatively large number, the intra-frequency interference is inevitably in both of the single-frequency network and the multi-frequency network.

In traditional solutions for reducing intra-frequency interference, the access devices exchange scheduling configuration with other access devices of the neighbor cells. However, the environment of the wireless communication changes complicatedly over time. The traditional solutions cannot adapt to the complicated change of the communication environment.

Another key factor affecting the performance of the communication of network is transmission power. More specifically, the access device may improve its performance by increasing the transmission power of itself. However, if the access device increasing the transmission power regardless of the neighbor cells, it may cause more interference to its neighbor cells. As a result, the overall performance of the communication system is reduced.

Therefore, it is desirable to provide a mechanism that can effectively reduce the intra-frequency interference, and also desirable to provide a mechanism that can optimize the parameter (such as, transmission power), such that the overall performance of communication system may be maximized or improved.

As an emerging technology, machine learning has been widely used in various fields. By selecting the training data appropriately, a model trained with machine learning may provide a result quickly and accurately. Therefore, technology of machine learning may be used for improving the performance of the communication system, such as, reducing interference and optimizing parameters (for example, transmission power).

Regarding reducing interference, inventors of the present discourse notice that in case that multiple neighbor cells re-use the same frequency band, intra-frequency interference on a specific frequency resource, especially for uplink interference, has a necessary correlation with the schedule of specific neighbor cells. As a result, the specific neighbor cells may be determined by previous information (such as, measured interference on the specific frequency resource and previous scheduling information of the neighbor cells on the specific frequency resource).

In view of the above, according to example embodiments of the present disclosure, there is proposed a solution for reducing interference in communication system. In this solution, the first device (such as, a network device) measures interference on a frequency resource in a scheduling interval. If the measured interference exceeds a threshold, the first device may determine an interfering device from a plurality of candidate devices (such as, the access devices of the neighbor cells) correlated with the interference, and then transmit a first message indicating that the interfering device is correlated with the interference measured by the first device. In particular, the model is trained with previous interference measured on the frequency resource in previous scheduling intervals and previous scheduling information of the plurality of candidate devices on the frequency resource in the previous scheduling intervals. In this way, the cell which is correlated with the interference may be identified more accurately and timely. As a result, the interference may be reduced accordingly.

Regarding optimizing parameter, inventors of the present discourse also notice that one or more core devices also are deployed in a relatively large area comprising multiple cells, where each cell has a corresponding access device for providing services to the terminal devices in the cell. Further, the access devices are connected to the core device and the core devices provide mobility management and session management function for the access devices. Therefore, the core may function as a central device to collect performance information over the communication system, and then determine and provide respective parameter to the network devices by using a model trained with machine learning, such that the overall performance of the communication system may be improved.

In view of the above, according to further example embodiments of the present disclosure, there is proposed a solution for optimizing parameter in communication system. In this solution, the second device (such as, a network device) determines performance information about the second device in an adjusting interval based on a set of performance indicators of the second device, and the second device transmits the performance information to a third device (such as, a core device). Then, the third device determines, based on the received performance information, respective parameters for adjusting transmission power to be used by the plurality of devices (such as, the access devices of the neighbor cells) in a subsequent adjusting interval, such that overall performance of the plurality of devices is maximized. The third device transmits the respective parameters to the plurality of devices. In this way, the overall performance of the communication system may be maximized and improved accordingly.

The above two procedures (i.e., procedure for reducing interference and procedure for optimizing parameter) for improving performance of the communication system will be described in detail in the following content. It is to be understood that although the above two procedures are described independently, these two procedures may be executed in parallel in the communication system.

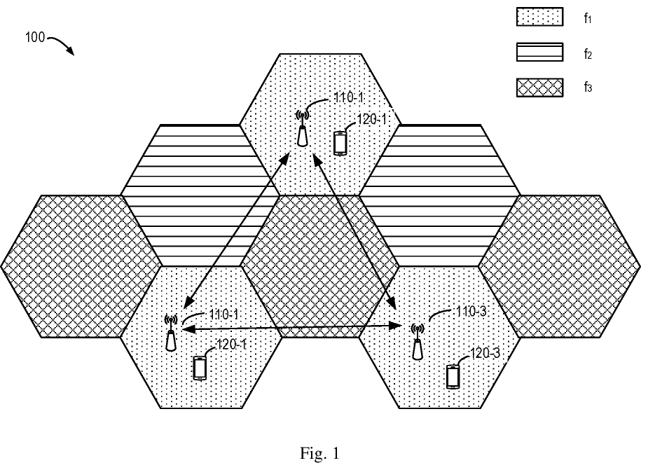

First, reference is made to FIGS. 1-3, with which the solution for reducing interference is discussed in details.

FIG. 1 shows an example communication network 100 in which some example embodiments of the present disclosure can be implemented. The example communication network 100 includes devices 110-1 to 110-3 (sometimes also referred to as first devices 110-1 to 110-3 herein) and devices 120-1 to 120-3 (such as, terminal devices). For purpose of discussion, the first devices 110-1 to 110-3 are collectively referred to as the first devices 110 or individually referred to as a first device 110, and the device 120-1 to 120-3 are collectively referred to as the devices 120 or individually referred to as a device 120). The first devices 110 may be devices of any suitable type. For purpose of discussion, in the example of FIG. 1, the first devices 110 are illustrated as network devices serving terminal devices. It is to be understood the first devices 110 may be terminal devices, core devices or other network entities in the other example embodiments. As shown in FIG. 1, the first devices 110-1 to 110-3 may communicate with each other via physical communication channels or links, and may communicate with the respective devices 120-1 to 120-3 via physical communication channels or links.

The serving areas of the network devices are called as cells. In the example of FIG. 1, eight cells are illustrated in the example communication network 100. Further, three frequency bands f₁, f₂ and f₃ are re-used among the eight cells. In particular, the first devices 110-1 to 110-3 re-use frequency band f₁.

Each of the frequency bands f₁, f₂ and f₃ is divided from the total frequent band available in the communication system. Further, each of the frequency bands f₁, f₂ and f₃ may be further divided into multiple frequency resources (such as, PRBs) during performing uplink and downlink transmission. The first devices 110-1 to 110-3 may schedule one or more frequency resources and allocate the scheduled frequency resources to the devices 120-1 to 120-3. Further, as frequency bands f₁ is reused by the first devices 110-1 to 110-3, the frequency resources scheduled among the devices first 110-1 to 110-3 may be partly overlapped. In this event, intra-frequency interference, especially uplink intra-frequency interference may occur accordingly.

It is to be understood that that although three frequency bands f₁, f₂ and f₃ and eight cells are illustrated in FIG. 1, in other example embodiments, the numbers of the frequency bands and the cells may any suitable numbers. Further, the mappings between the frequency bands and the cells illustrated in FIG. 1 are only for the purpose of illustration without suggesting any limitations. The scope of the embodiments of the present disclosure is not limited in this regard. In particular, although the example communication network 100 is illustrated as a multi-frequency network, the communication network 100 may also be a single-frequency network. In case that the communication network 100 is a single-frequency network, each of the eight cells has a respective first device 110 and a same frequency band is used by each of the eight cells as illustrated in FIG. 1. Further, as the intra-frequency interference is relative more serious compared with the multi-frequency network, the single-frequency network will benefit more from the solution of the present disclosure.

It is to be understood that the number and type of devices in FIG. 1 are given for the purpose of illustration without suggesting any limitations to the present disclosure. The communication network 100 may include any suitable numbers first devices 110 and devices 120 adapted for implementing embodiments of the present disclosure. Further, the example communication network 100 may include any other devices than the network devices and the terminal devices, such as a core network element, but they are omitted here so as to avoid obscuring the present invention.

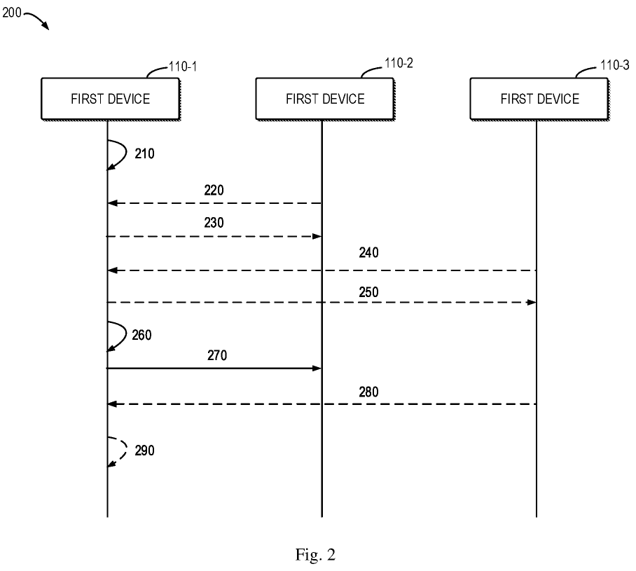

Principle and implementations of reducing interference (especially the intra-frequency interference) will be described in detail below with reference to FIG. 2, which shows example signaling chart 200 for reducing interference between devices in accordance with some embodiments of the present disclosure.

It is to be understood that the method may be implemented at any suitable devices according to the specific implements. Only for the purpose of illustrations, the signaling chart 200 is described to be implemented between the first devices 110-1 to 110-3 as shown in FIG. 1. Further, the sequence of the signalings and actions in FIG. 2 is shown only for the purpose of illustrations. The sequence of the signalings and actions illustrated in signaling chart 200 may be performed in any suitable sequence adapted for implementing embodiments of the present disclosure.

It is to be understood that the first devices 110 may be devices of any suitable. For purpose of discussion, in the method of example signaling chart 200, the first devices 110 are implemented as network devices. In addition, the first devices 110-1 to 110-3 are homologous. In other words, the functions described for the first device 110-1 also are suitable for the first device 110-2 and 110-3.

As shown in FIG. 1, the first devices 110-1 to 110-3 re-use a frequency f₁ which is divided from the total frequent band available in the communication system. The frequency band f₁ is further divided into multiple frequency resources (such as, PRBs) during performing uplink and downlink transmissions. The first devices 110-1 to 110-3 may schedule one or more frequency resources and allocate the scheduled frequency resources to the devices 120-1 to 120-3. The devices 120-1 to 120-3 may perform uplink or downlink transmission on the allocated frequency resources. Further, as the first devices 110-2 and 110-3 are neighbor cells of the first device 110-1, in case that the frequency resources scheduled among the first devices 110-1 to 110-3 are partly overlapped, the data transmitted to one of the first devices 110 would also be received by the other first devices, which is referred to as intra-frequency interference.

The first device 110-1 measures 210 interference on a frequency resource in a scheduling interval. The frequency resource may comprise at least one PRB. The size of the frequency resource may be determined based on the requirements of power consumption and scheduling complexity. In some example embodiments, the frequency resource comprises one PRB. In this way, the interference can be measured on a suitable resource unit, which does not consume too much power and also suitable for scheduling.

In some example embodiments, the first device 110-1 may measure interference on a plurality of frequency resources (such as, a plurality of PRBs), where the plurality of frequency resources is part of the whole frequency band which is available for the first device 110-1. The number of frequency resources to be measured may be determined by the first device 110-1 based on the requirement of power consumption. As an example, the first device 110-1 may only measure interference on the frequency resources that the first device 110-1 intent to schedule in the following scheduling intervals. Alternatively, the first device 110-1 may measure all the available frequency resources.

The scheduling interval may be pre-configured by the first device 110-1 or other network element (such as, a core device) according to a requirement of signaling overhead. In some example embodiments, the scheduling interval is one second. In this way, the first device 110-1 may detect the interference and trigger an avoiding procedure in time without a significant increased signaling overhead.

In some example embodiments, strength of the interference may be represented as a power value. Alternatively, in some other example embodiments, the strength the interference may be represented as power level. It is to be understood that the strength of the interference can be represented in any suitable form and the scope of the embodiments of the present disclosure is not limited in this regard.

If the first device 110-1 determines that the strength of the interference measured on the frequency resource exceeds acceptable interference strength, the first device 110-1 determines 260 an interfering device from a plurality of candidate devices by using a trained model, where the interfering device is correlated with the interference.

The acceptable interference strength may be represented in any suitable form. In some example embodiments, the acceptable interference strength is represented as a threshold of power value. Alternatively, in some other example embodiments, the acceptable interference strength is represented as threshold of power level.

In some embodiments, the acceptable interference strength may be pre-configured by a network element (such as, the first device 110-1, or a core device). Alternatively, or in addition, the threshold may be dynamically adjusted by the first device 110-1. Further, the model discussed herein is trained with strength of previous interference measured on the frequency resource in previous scheduling intervals and previous scheduling information of the plurality of candidate devices on the frequency resource in the previous scheduling intervals.

In some example embodiments, the scheduling information of the candidate device indicates that at least a part of the scheduling interval is used by the candidate device. As an example, the scheduling information is represented as a percentage of time, which indicates the scheduling ratio on the frequency resource (such as, a specific PRB) in the scheduling interval. In some example embodiments, the model is built by first device 110-1 itself previously. Alternatively, the model also may be built by anther suitable device previously. Further, the model may be updated and optimized dynamically when running on the first device 110-1.

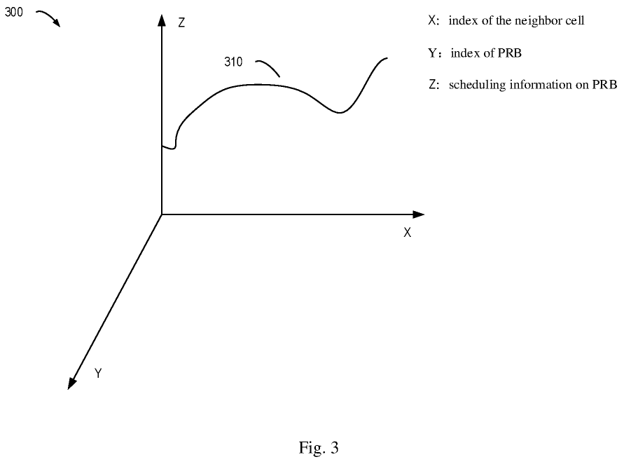

FIG. 3 illustrates an example graph 300 of the function for generating the model in accordance with some embodiments of the present disclosure. In the example of FIG. 3, the X axis represents the index of the neighbor cell (such as, first device 110-2 and first device 110-3), the Y axis represents the index of PRB (such as, Physical Uplink Shared Channel (PUSCH) PRB) and the Z axis represents the scheduling information of the neighbor cell on PRB (such as, a percentage of time). The curve 310 illustrated in FIG. 3 represents the correlation among the neighbor cell, the scheduling information and the index of PRB. The correlation represented by curve 310 may be used by the model discussed herein. The procedure of fitting the curve 310 (also referred as a procedure modeling) is executed by machine learning based on the strength of previous interference measured on the frequency resource in previous scheduling intervals and previous scheduling information of the plurality of candidate devices on the frequency resource in the previous scheduling intervals.

Now, a detailed modeling procedure is discussed as below. For purpose of discussion, in following modeling procedure is based on the assumption that the model is built by the first device 110-1. It is to be understood that the modeling procedure also may be performed by other suitable devices.

The first device 110-1 obtains the interference strength on at least one of frequency resources (such as, PRBs) in previous scheduling intervals by such as measuring interference on the at least one of frequency resources. Meanwhile the first device 110-1 obtains scheduling information on the frequency resources in the previous scheduling intervals and creates time series matrix with the received scheduling information. The first device 110-1 may obtain the scheduling information by receiving the scheduling information from respective neighbor cells in each of the previous scheduling intervals. For each scheduling interval, the first device 110-1 will get N*M data samples, where N is the number of neighbor cells and M is the number of the at least one of frequency resources. The first device 110-1 maintains the obtained interference strength and the scheduling information in each scheduling interval.

Below table 1 is an example of N*M data samples and the interference maintained by the first device 110-1.

TABLE 1
Example of N*M data samples and the interference

| | | Shecduling | | Shecduling |
|---|---|---|---|---|
| Index | Interference | Information | | Information |
| of PRB | level | of Cell 1 | . . . | of Cell N |
| 001 | 0 | 10% | . . . | 30% |
| 002 | 5 | 50% | . . . | 50% |
| 003 | 3 | 20% | . . . | 35% |
| . . . | . . . | . . . | . . . | . . . |
| 099 | 4 | 25% | . . . | 15% |
| M | 0 | 14% | . . . | 20% |

It is to be understood that the numbers of the PRBs and neighbor cell (i.e., first device 110-2 and first device 110-3) are only for the purpose of illustration without suggesting any limitations. Further, the values and representation form of interference and scheduling information also are only for the purpose of illustration without suggesting any limitations.

The first device 110-1 generates the model by machine learning based on the obtained interference and the scheduling information in each of scheduling intervals. Then, the first device 110-1 may find the association relationship between the interference on the specific frequency resource (i.e., PRB) and the scheduling information of the neighbor cell on the specific frequency resource.

In some example embodiments, first device 110-1 generates the model based on a Bayesian multivariate linear regression algorithm. In this way, the first device 110-1 may identify the neighbor cell correlated with the interference (for example, the neighbor cell which has the highest correlation with the interference on the specific frequency resource (i.e., the specific PRB)) more accurately.

In this way, in case that the first device 110-1 determines that the measured interference on a frequency resource exceeds an acceptable interference strength, the first device 110-1 may determine the device which contributes the most the interference on the frequency resource accurately and quickly. For example, the first devices 110-1 to 110-3 receive uplink transmission simultaneously in a scheduling interval. In case that the first device 110-1 determines that the strength of the interference on a frequency resource exceeds a threshold, it would be difficult to determine that whether the interference on the frequency resource is mainly caused by the first device 110-2 or the first device 110-3, because both the first device 110-2 and 110-3 perform schedule on the frequency resource. However, by using the model discussed herein, the first device 110-1 may easily determine the device correlated with the interference on the frequency resource, because the model is well trained with the data samples in multiple previous scheduling intervals.

Still in reference to FIG. 2, in some example embodiments, the first device 110-1 receives scheduling information of the plurality of candidate devices on the frequency resource in the scheduling interval. More specifically, the first device 110-1 receives 220 scheduling information from the first device 110-2 and receives 240 scheduling information from the first device 110-3. The first device determines 260 the interfering device based on the interference measured in the scheduling interval and the received scheduling information by using the model. In some example embodiments, the first device 110-2 and the first device 110-3 may transmit scheduling information of the devices 110-2 and 110-3 on a plurality of frequency resources (such as, PRBs). Further, the plurality of frequency resources may be a part of the frequency band available for the first devices 110-2 and 110-3, such as, the selected PRB scheduled in the scheduling interval.

In this way, the latest scheduling information of the plurality of candidate devices is considered as a parameter for determining the interfering device. Thus, the accuracy of result determined by the first device 110-1 can be improved.

Additionally, in some example embodiments, the first device 110-1 transmits the scheduling information of the first device 110-1 on the frequency resource to the plurality of candidate devices. More specifically, the first device 110-1 transmits 230 the scheduling information to the first device 110-2 and transmits 250 the scheduling information to the first device 110-3. In some example embodiments, the first device 110-1 may transmit scheduling information of the first device 110-1 on a plurality of frequency resources (such as, PRBs). Further, the plurality of frequency resources may be a part of the frequency band available for the first device 110-1, such as, the selected PRB scheduled in the scheduling interval.

In this way, the neighbor cells (such as, the first device 110-2 and first device 110-3) may obtain the scheduling information of the first device 110-1, such that in case that the neighbor cell suffers an interference, the neighbor cell may determine the source of the interference accordingly.

Upon the first device 110-1 determines the interfering device correlated with the interference, the first device 110-1 transmits 270 to the interfering device (for example, the first device 110-2) a first message indicating that the interfering device is correlated with the interference.

In this way, the first device 110-1 may inform the first device 110-2 about the interference on the specific frequency resource, such that the first device 110-2 may perform a procedure to avoid the scheduling conflict on the specific frequency resource, and the interference on the specific frequency resource may be reduced accordingly. For example, the first device 110-2 may reduce possibility of the frequency resource to be scheduled in a subsequent scheduling interval.

Alternatively, the first device 110-1 may receive 280 a second message indicating that the first device 110-1 is correlated with interference on a further frequency resource (for example, a further PRB) measured by an interfered device (for example, the first device 110-3) of the plurality of candidate devices.

The first device 110-1 reduces 290 possibility of the further frequency resource to be scheduled in a subsequent scheduling interval. As an example, the first device 110-1 may reduce the weight of the further frequency resource when selecting PRBs to be scheduled. As another example, reducing the possibility of the further frequency resource may be implemented by applying additional priority to current UL scheduling mechanism (for example, uplink channel awareness scheduling) during PRB selection procedure. As a result, the first device 110-1 may reduce the interference to another neighbor cell as an interfering device.

In this way, by using a model based on machine learning, the cell which is correlated with the interference on a specific frequency resource (such as, a specific PRB) may be identified more accurately and timely. As a result, the interference may be reduced accordingly.

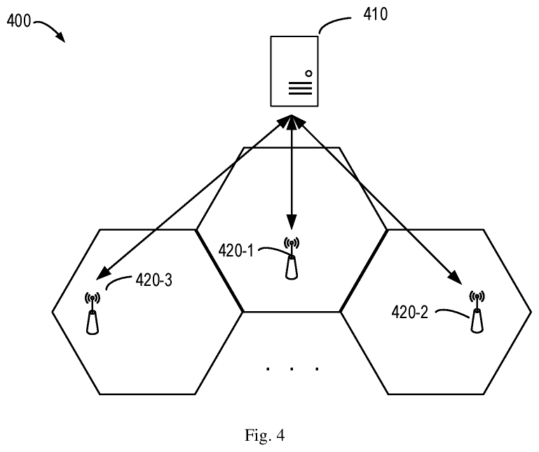

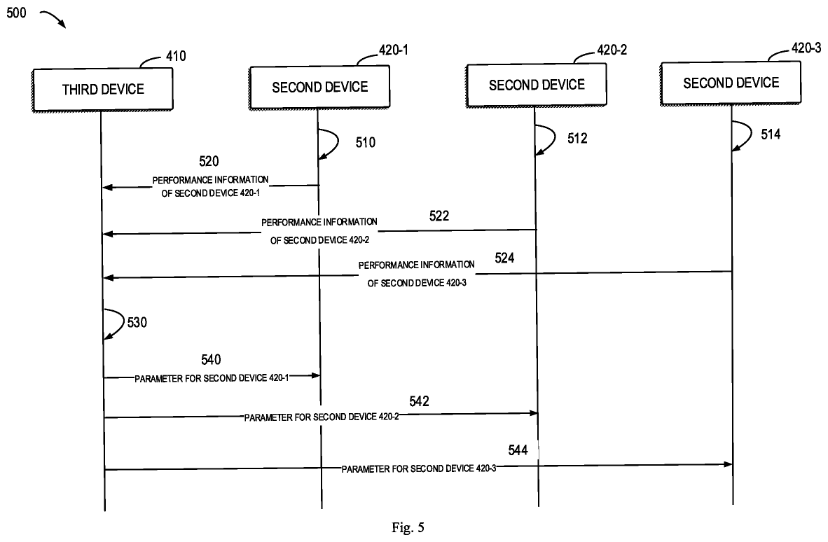

The above content is about the procedure of reducing interference. Reference is now made to FIGS. 4 and 5, with which the procedure of optimizing parameter will be described in details.

FIG. 4 shows another example communication network 400 in which some example embodiments of the present disclosure can be implemented. The example communication network 400 includes devices 420-1 to 420-3 (sometimes also referred to as second devices herein) and device 410 (sometimes also referred to as third device herein). For purpose of discussion, the second devices are collectively referred to as the second devices 420 or individually referred to as a second device 420. The second devices 420 and the third device 410 may be devices of any suitable. For purpose of discussion, in the example of FIG. 4, the second devices 420 are illustrated as network devices and the third device is illustrated as core device. As shown in FIG. 4, the second devices 420-1 to 420-3 may communicate with the third device 410 via physical communication channels or links.

The serving areas of the network devices are called as cells. In the example of FIG. 4, three cells are illustrated in the example communication network 400. It is to be understood that the homogeneous network deployment and the heterogeneous network deployment may be included in the example communication network 400 and the number cells is given for the purpose of illustration without suggesting any limitations to the present disclosure.

Further, it is to be understood that the number and type of devices in FIG. 1 are given for the purpose of illustration without suggesting any limitations to the present disclosure. The communication network 400 may include any suitable numbers the second devices 420 and the third device 410 adapted for implementing embodiments of the present disclosure. In addition, the example communication network 400 may include any other devices than the network devices and the core device, such as terminal devices, but they are omitted here so as to avoid obscuring the present invention.

Principle and implementations of optimizing parameter will be described in detail below with reference to FIG. 5, which shows example signaling chart 500 for optimizing parameter between devices in accordance with some embodiments of the present disclosure. It is to be understood that the method may be implemented at any suitable devices according to the specific implements. Only for the purpose of illustrations, the signaling chart 500 are described to be implemented between the second devices 420-1 to 420-3 and the third device 410 as shown in FIG. 4.

It is to be understood the sequence of the signaling and actions in FIG. 4 is shown only for the purpose of illustrations. The sequence of the signaling and actions illustrated in signaling chart 200 may be performed in any suitable sequence adapted for implementing embodiments of the present disclosure.

It is to be understood that the second devices 420 and the third device 410 may be devices of any suitable. For purpose of discussion, in the method of example signaling chart 500, the second devices 110 are implemented as network devices, and the third device 410 is implemented as core device. In addition, the second devices 420-1 to 420-2 are homologous. In other words, the functions described for the second device 420-1 also are suitable for the second device 420-2 and 420-3.

The second device 420-1 determines 510 performance information about the second device 420-1 in an adjusting interval based on a set of performance indicators of the second device 420-1. The adjusting interval may be any suitable time period, such as, fifteen minutes, one hour, or other time period.

In some example embodiments, the set of performance indicators comprises a success rate of Radio Resource Control (RRC) establishment or a failure rate of RRC establishment. The success rate of RRC establishment or the failure rate of RRC establishment is a key performance indicator and can reflect the status of ability of allowing the user to access the network. In this way, the number of the users in the communication network can be well evaluated.

Alternatively, or in addition, the set of performance indicators comprise a success rate of bearer establishment or a failure rate of bearer establishment. The success rate of bearer establishment or the failure rate of bearer establishment is a key performance indicator and can reflect the status of ability of providing resource for the traffic. In this way, the load status of the communication network can be well evaluated.

It is should be understand that the above performance indicators are given for the purpose of illustration without suggesting any limitations to the present disclosure. Any suitable performance indicators may be used for determining the performance information and the scope of the present disclosure is not limited in this regard.

In some example embodiment, the second device 420-1 determines a score for each performance indicator of the set of performance indicators and determines the performance information by summing scores of the set of performance indicators. In this way, the performance of the second device 420-1 is represented intuitively and simply.

In some example embodiment, the performance indicator may be a key performance indicator (KPI) measured by the second device 420-1. In this way, the second device 420-1 may determine the performance information without any additional measurements.

In addition, the second device 420-1 may determine the performance information according to a pre-configured policy. The pre-configured policy may stipulate and define any suitable items or rules for determining performance information. In particular, the pre-configured policy may stipulate and define any suitable items or rules for each performance indicator. As an example, the pre-configured policy for each performance indicator may comprise at least part of the following items or rules illustrated in Table 2.

TABLE 2
example items or rules for each performance indicator
comprised in the pre-configured policy

| Items or Rules | Physical Meaning |
|---|---|
| KPI ID | identity of KPI |
| weight | used to coefficient of each KPI |
| category | KPI type |
| direction | a positive relationship represented as |
| | character “H”, which means that the higher |
| | the value, the better the performance; or |
| | a negative relationship represented as |
| | character “L”, which means that the lower |
| | the value, the better the performance |
| daily abnormal | a configured threshold value for the KPI in |
| threshold for comparison | case that the detection interval is one day |
| hourly abnormal | a configured threshold value for the KPI in |
| threshold for comparison | case that the detection interval is one hour |
| estimation interval | a time period for detecting KPI, such as, |
| | fifteen minutes, one hour, one day, one |
| | week, and so on |
| scoring criterion | stipulating the score and the detected |
| | value of the KPI |

Item “KPI ID” may be used to identify the KPI. Item “weight” may be used to coefficient among multiple KPIs. More specifically, the value of weight is configured according to the importance of the KPI. Item “category” may be used to indicate the type of the KPI. Item “direction” may be used to reflect the relationship between the performance of the second device 420 and the value of the KPI. More specifically, a positive relationship represented as character “H”, which means that the higher the value, the better the performance, and a negative relationship represented as character “L”, which means that the lower the value, the better the performance. Items “daily abnormal threshold for comparison” and “hourly abnormal threshold for comparison” may be used to define threshold values for the abnormal status. Item “estimation interval” may be used for stipulating the time period for detecting KPI. Rule “scoring criterion” may be used for stipulating correlation between the score and the detected value of the KPI. For example, the scoring criterion may be a non-linear function or a linear function.

It is should be understand that the above items and rules illustrated in Table 2 are given for the purpose of illustration without suggesting any limitations to the present disclosure. Any suitable items and rules may be comprised in the pre-configured policy and the scope of the present disclosure is not limited in this regard.

It is to be understood that the items or rules illustrated on above Table 2 are shown only for the purpose of illustrations without suggesting any limitation. In other example embodiments, any suitable items or rules may be stipulated and defined by the pre-configured policy. Further, the example of success rate and failure rate are discussed only for the purpose of illustrations without suggesting any limitation. In other example embodiments, other KPIs may be used for determining the performance information.

The following Table 3 shows an example of pre-configured policy.

TABLE 3
Example of pre-configured policy

| Items or Rules | success rate of RRC establishment |
|---|---|
| KPI ID | LTE_123 |
| weight | 80% |
| category | success rate (SR) |
| direction | H |
| daily abnormal | 99.5% |
| threshold for comparison | |
| hourly abnormal | 99.7% |
| threshold for comparison | |
| estimation interval | one day |
| scoring criterion | in case that success rate of RRC establishment |
| | less than 99.5%, determine score is 0; |
| | in case that success rate of RRC establishment |
| | less than 99.5%, determine that the score is 0; |
| | in case that success rate of RRC establishment |
| | is between 99.5% and 99.7, determine that the |
| | score is 50; and |
| | in case that success rate of RRC establishment |
| | exceeds 99.7%, determine that the score 75; |

Similar with the second device 420-1, the second device 420-2 determines 512 performance information about the second device 420-2, and the second device 420-3 determines 514 performance information about the second device 420-3. If the performance information is determined according to a same pre-configured policy, the second device 420-2 and the second device 420-3 should apply the same pre-configured policy with the second device 420-1. In this way, the third device 410 may perform a more fairer schedule.

The second device 420-1 transmits 520 the determined performance information to the third device 410, the second device 420-2 transmits 522 the determined performance information to the third device 410, and the second device 420-3 transmits 524 the performance information to the third device 410.

In this way, the third device 410 may receive respective performance information in an adjusting interval from a plurality of devices, such that third device 410 may obtain an overall performance of the communication system.

The third device 410 determines 530 respective parameters for adjusting transmission power to be used by the plurality of devices in a subsequent adjusting interval based on the received performance information, such that overall performance of the plurality of devices is maximized.

In some example embodiments, parameter for adjusting transmission power is parameter for uplink transmission comprised in the power control command. Since the transmission power may influence the throughput of the communication system and the interference among neighbor cells directly, the overall performance of the communication system may be maximized quickly.

In some example embodiments, third device 410 determines a target function measuring the overall performance based on the received performance information and the parameters to be determined. Further, the third device 410 determines the respective parameters by maximizing the target function. In some example embodiments, the third device 410 determines the target function, based on the received performance information, the parameters to be determined and respective weights of the plurality of devices. In this way, the overall performance of the communication is maximized. Further, the parameters can be derived by the third device 410 by using a model trained machine leaning. In this way, the parameters may be derived more accurately and rapidly.

In one example embodiments, the third device 410 assigns a weight to each of the cells in the communication system, and the overall performance may be represented as N₁*W₁+N₂*W₂+ . . . +Nₙ*Wₙ, where N₁ to Nₙ are performance information of respective cell 1 to cell n, and W₁ to Wₙ are weights of respective cell 1 to cell n.

In this way, the performance of importance cell may be guaranteed, and further the communication system enables different performance requirements for different cells.

Then, third device 410 transmits 540, to the second device 410-1, the determined respective parameter for adjusting transmission power to be used by the second device 420-1 in a subsequent adjusting interval. In addition, the third device 410 also transmits 542 the determined respective parameter for adjusting transmission power to the second device 420-2 and transmits 544 the determined respective parameter for adjusting transmission power to the second device 420-3. In this way, the the overall performance of the communication system may be maximized.

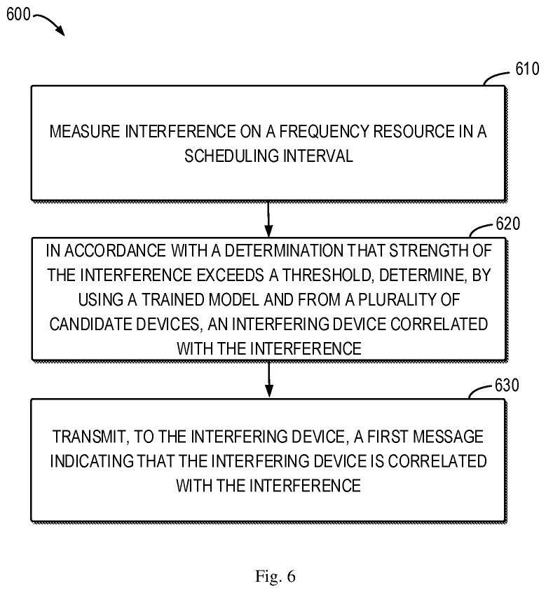

FIG. 6 shows a flowchart of an example method 600 implemented at a first device 110 in accordance with some example embodiments of the present disclosure. For the purpose of discussion, the method 600 will be described from the perspective of the first device 110 with respect to FIG. 1. It is to be understood that the method 600 may include additional blocks not shown and/or may omit some shown blocks, and the scope of the present disclosure is not limited in this regard.

At block 610, the first device 110 measures interference on a frequency resource in a scheduling interval. At block 620, the first device 110 determines, by using a trained model and from a plurality of candidate devices, an interfering device correlated with the interference in accordance with a determination that the interference exceeds a threshold. At block 630, the first device 110 transmits a first message indicating that the interfering device is correlated with the interference to the interfering device.

In some example embodiments, the first device 110 receives, from an interfered device of the plurality of candidate devices, a second message indicating that the first device 110 is correlated with interference measured by the interfered device on a further frequency resource in the scheduling interval. Further, the first device 110 reduces possibility of the further frequency resource to be scheduled in a subsequent scheduling interval.

In some example embodiments, the first device 110 receives from the plurality of candidate devices, scheduling information of the plurality of candidate devices on the frequency resource in the scheduling interval. Further, the first device 110 determines, by using the model, the interfering device based on the interference measured in the scheduling interval and the received scheduling information.

In some example embodiments, the first device 110 transmits, to the plurality of candidate devices, scheduling information of the first device 110 on the frequency resource in the scheduling interval.

In some example embodiments, the model is generated based on a Bayesian multivariate linear regression algorithm.

In some example embodiments, the frequency resource comprises at least one physical resource block.

In some example embodiments, the first device 110 is a network device.

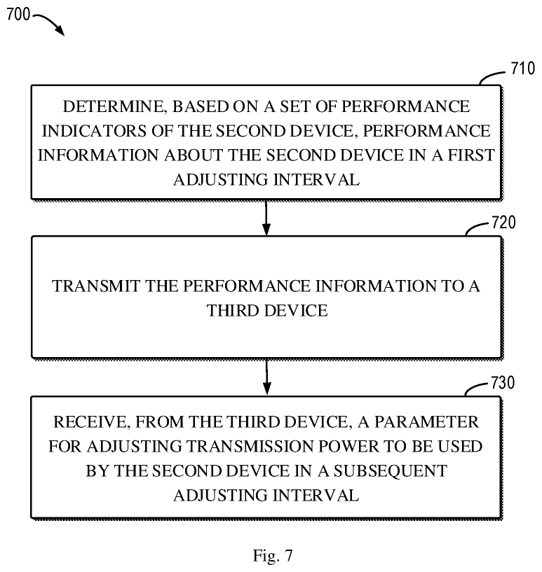

FIG. 7 shows a flowchart of an example method 700 implemented at a second device 420 in accordance with some example embodiments of the present disclosure. For the purpose of discussion, the method 700 will be described from the perspective of the second device 420 with respect to FIG. 4. It is to be understood that the method 700 may include additional blocks not shown and/or may omit some shown blocks, and the scope of the present disclosure is not limited in this regard.

At block 710, the second device 420 determines, based on a set of performance indicators of the second device 420, performance information about the second device 420 in an adjusting interval. At block 720, the second device 420 transmits the performance information to a third device 410. At block 730, the second device 420 receives, from the third device 410, a parameter for adjusting transmission power to be used by the second device 420 in a subsequent adjusting interval. The parameter is determined based on respective performance information of a plurality of devices comprising the second device 420 to maximum overall performance of the plurality of devices.

In some example embodiments, the second device 420 determines a score for each performance indicator of the set of performance indicators and determines the performance information by summing scores of the set of performance indicators.

In some example embodiments, the set of performance indicators comprises at least one of the following: a success rate of Radio Resource Control establishment, a success rate of bearer establishment, a failure rate of Radio Resource Control establishment, and a failure rate of bearer establishment.

In some example embodiments, the second device 420 is a network device and the third device 410 is a core device.

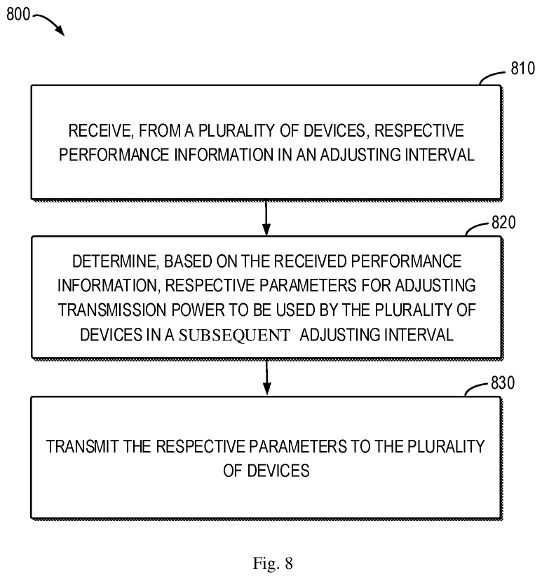

FIG. 8 shows a flowchart of an example method 800 implemented at a first device 410 in accordance with some example embodiments of the present disclosure. For the purpose of discussion, the method 800 will be described from the perspective of the third device 410 with respect to FIG. 4. It is to be understood that the method 800 may include additional blocks not shown and/or may omit some shown blocks, and the scope of the present disclosure is not limited in this regard.

At block 810, the third device 410 receives, from a plurality of devices, respective performance information in an adjusting interval.

At block 820, the third device 410 determines, based on the received performance information, respective parameters for adjusting transmission power to be used by the plurality of devices in a subsequent adjusting interval, such that overall performance of the plurality of devices is maximized.

At block 830, the third device 410 transmits the respective parameters to the plurality of devices.

In some example embodiments, the set of performance indicators comprises at least one of the following: a success rate of Radio Resource Control establishment, a success rate of bearer establishment, a failure rate of Radio Resource Control establishment, and a failure rate of bearer establishment.

In some example embodiments, the third device 410 determines, based on the received performance information and the parameters to be determined, a target function measuring the overall performance. The third device 410 further determines the respective parameters by maximizing the target function.

In some example embodiments, the third device 410 determines the target function, based on the received performance information, the parameters to be determined and respective weights of the plurality of devices.

In some example embodiments, the third device 410 is a core device and the plurality of devices are network devices.

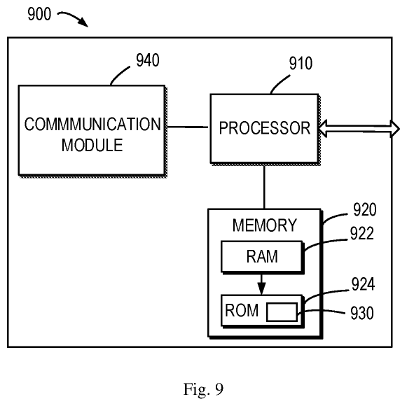

FIG. 9 is a simplified block diagram of a device 900 that is suitable for implementing example embodiments of the present disclosure. The device 900 may be provided to implement the communication device, for example the first device 110 as shown in FIG. 1, the second device 420 as shown in FIG. 4 or the third device 410 as shown in FIG. 4. As shown, the device 900 includes one or more processors 910, one or more memories 940 coupled to the processor 910, and one or more transmitters and/or receivers (TX/RX) 940 coupled to the processor 910.

The TX/RX 940 is for bidirectional communications. The TX/RX 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 1020. The processor 910 may perform any suitable actions and processing by loading the program 930 into the RAM 920.

The example embodiments of the present disclosure may be implemented by means of the program 930 so that the device 900 may perform any process of the disclosure as discussed with reference to FIGS. 3 to 8. The example embodiments of the present disclosure may also be implemented by hardware or by a combination of software and hardware.

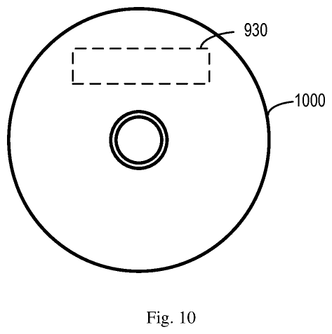

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600, 700 and 800 as described above with reference to FIGS. 6-8. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single example embodiment. Conversely, various features that are described in the context of a single example embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program code;
wherein the at least one memory and the computer program code are configured to, with the at least one processor, cause the first device to:
measure interference on a frequency resource in a first scheduling interval;
in accordance with a determination that strength of the interference exceeds a threshold, determine, by using a trained model and from a plurality of candidate devices, an interfering device correlated with the interference, the model being trained with strength of previous interference measured on the frequency resource in previous scheduling intervals and previous scheduling information of the plurality of candidate devices on the frequency resource in the previous scheduling intervals; and
transmit, to the interfering device, a first message indicating that the interfering device is correlated with the interference.

2. The first device of claim 1, wherein the at least one memory and the computer program code are configured to, with the at least one processor, further cause the first device to:
receive, from an interfered device of the plurality of candidate devices, a second message indicating that the first device is correlated with interference measured by the interfered device on a further frequency resource in the scheduling interval; and
reduce possibility of the further frequency resource to be scheduled in a subsequent scheduling interval.

3. The first device of claim 1, wherein the at least one memory and the computer program code are configured to, with the at least one processor, cause the first device to determine the interfering device by:
receiving, from the plurality of candidate devices, scheduling information of the plurality of candidate devices on the frequency resource in the scheduling interval; and
determining, by using the model, the interfering device based on the interference measured in the scheduling interval and the received scheduling information.

4. The first device of claim 1, wherein the at least one memory and the computer program code are configured to, with the at least one processor, further cause the first device to:
transmit, to the plurality of candidate devices, scheduling information of the first device on the frequency resource in the scheduling interval.

5. The first device of claim 1, wherein the model is generated based on a Bayesian multivariate linear regression algorithm.

6. The first device of claim 1, wherein the frequency resource comprises at least one physical resource block.

7. The first device of claim 1, wherein the first device is a network device.

8. A second device comprising:
at least one processor; and
at least one memory including computer program code;
wherein the at least one memory and the computer program code are configured to, with the at least one processor, cause the second device to:
determine, based on a set of performance indicators of the second device, performance information about the second device in an adjusting interval;
transmit the performance information to a third device; and
receive, from the third device, a parameter for adjusting transmission power to be used by the second device in a subsequent adjusting interval, the parameter being determined based on respective performance information of a plurality of devices comprising the second device to maximum overall performance of the plurality of devices.

9. The second device of claim 8, wherein the at least one memory and the computer program code are configured to, with the at least one processor, cause the second device to determine the performance information by:
determining a score for each performance indicator of the set of performance indicators; and
determining the performance information by summing scores of the set of performance indicators.

10. The second device of claim 8,
wherein the set of performance indicators comprises at least one of the following:
a success rate of Radio Resource Control establishment,
a success rate of bearer establishment,
a failure rate of Radio Resource Control establishment, and
a failure rate of bearer establishment.

11. The second device of claim 8, wherein the second device is a network device and the third device is a core device.

12. A third device comprising:
at least one processor; and
at least one memory including computer program code;
wherein the at least one memory and the computer program code are configured to, with the at least one processor, cause the third device to:
receive, from a plurality of devices, respective performance information in an adjusting interval;
determine, based on the received performance information, respective parameters for adjusting transmission power to be used by the plurality of devices in a subsequent adjusting interval, such that overall performance of the plurality of devices is maximized; and
transmit the respective parameters to the plurality of devices.

13. The third device of claim 12, wherein the at least one memory and the computer program code are configured to, with the at least one processor, further cause the third device to:
assign respective weights to the plurality of devices.

14. The third device of claim 12, wherein the at least one memory and the computer program code are configured to, with the at least one processor, cause the third device to determine the respective parameters by:
determining, based on the received performance information and the parameters to be determined, a target function measuring the overall performance; and
determining the respective parameters by maximizing the target function.

15. The third device of claim 14, wherein the at least one memory and the computer program code are configured to, with the at least one processor, cause the third device to determine the target function by:
determining the target function, based on the received performance information, the parameters to be determined and respective weights of the plurality of devices.

16-38. (canceled)
